(19) United States
(12) Patent Application Publication
(10) Pub. No.: US 2007/0275152 A1
(43) Pub. Date: Nov. 29, 2007

(54) Animal Feed Compositions

(75) Inventors: David A. Cook, Coon Rapids, MN (US); Mark D. Newcomb, Independence, MN (US); Michael J. Beaver, Victoria, MN (US)

Correspondence Address: PERKINS COIE LLP;PATENT-SEA, P.O. BOX 1247, SEATTLE, WA, 98111-1247, US

(73) Assignee: Cargill Incorporated of Delaware, Wayzata, MN (US)

(21) Appl. No.: 10/574,975

(22) PCT Filed: Oct. 5, 2004
(86) PCT No.: PCT/US04/32851

§ 371 Date: Apr. 26, 2007

(51) Int. Cl. A23L 1/20

(52) U.S. Cl. 426/630

(57) ABSTRACT

The present disclosure describes a certain isoflavone-enhanced domestic animal feed compositions and methods of producing such feed compositions. In one particular implementation, a feed composition includes a soy meal that is no more than about 20 weight percent of the feed composition. This soy meal has a soy isoflavone content that provides the feed composition with a soy isoflavone concentration, normalized to an aglycone content of about 250-1400 parts per million on a weight basis (ppm), e.g., about 800-1200 ppm. Feed compositions in certain adaptations have demonstrated some advantages over feeds with lower isoflavone content.

### TECHNICAL FIELD

The present invention generally relates to feed compositions for domestic animals. More specifically, embodiments of the invention provide isoflavone-enhanced feed compositions, e.g., for domestic mammals, and methods of producing isoflavone-enhanced feed compositions.

### BACKGROUND

Soybeans have been eaten for thousands of years, both as cooked beans and as an ingredient in other food. Soybeans are also an important agricultural source of vegetable oils and vegetable proteins, both of which are used for animal consumption and for human consumption. Soybeans may be processed in a variety of ways, but soybean oil is typically isolated from the solids by extraction with an organic solvent. The solid soybean product that remains after extraction of the oil may be desolventized and toasted to form a defatted, toasted soy meal as a source of protein for animal feed. This soy meal may be found in feed compositions for a wide range of domestic animals, including livestock (e.g., chickens, swine, ruminants, and horses), and companion animals (e.g., dogs and cats).

Soybeans are also known as a good source of isoflavones, which are promoted as human dietary supplements that may be beneficial in the prevention of cancer, cardiovascular disease, and osteoporosis. Soy isoflavones include daidzin, glycitein, and genistein. In many instances, the isoflavones are chemically isolated from the bulk of the soybean to produce an isoflavone extract, which may include other components such as saponins and lignins. These isoflavones are naturally present in soybeans in both aglycone and glycosidic forms. The relative proportions of these forms may vary appreciably from one batch of soybeans to another. To facilitate reliable comparison to other reported values, isoflavones content may be expressed as the weight percent of the aglycone, with the weight of the glycosidic isoflavones being normalized by factoring out the weight contributed by the sugars.

Soybeans vary significantly (e.g., an order of magnitude or more) in isoflavone content depending on the soybean variety, growing conditions, and other factors. Soybeans grown commercially in the United States, though, commonly have isoflavone contents (on a normalized weight percent basis) on the order of about 0.150.3 weight percent (wt. %), commonly stated as 1500-3000 parts per million on a weight basis (ppm). It is impractical, therefore, to use unprocessed soybeans as a dietary supplement to significantly increase isoflavones in the diet. Most dietary supplements instead employ isoflavone extracts that are produced by chemically processing cracked soybeans, e.g., by dissolving in ethyl acetate then precipitating the isoflavones using ice water. (See, e.g., U.S. Pat. No. 6,261,565, the entirety of which is incorporated herein by reference.) Isoflavone dietary supplements are commercially available, e.g., from Cargill, Incorporated under the trademark ADVANTASOY.

Isoflavone concentration is not uniformly distributed throughout a soybean. Soybeans include three main components—the meat (about 94.5 wt. %), the germ (about 2 wt. %), and the hull (about 3.5 wt. %). There is little, if any, Isoflavone in the hulls. The isoflavone content (on a weight percent basis) of the germ is typically at least about three times, and often ten times or more, the isoflavone content of the meat. Consequently, some health food manufacturers have focused on the soy germ as a source of isoflavones. Soy germ products may be produced by at least partially isolating the germ from the meat and the hull to yield a soy germ concentrate (e.g., 30-90 wt. % germ, with the balance meat fragments and hulls). The oil in this soy germ concentrate may be extracted, leaving soy germ meal. Some useful methods for producing such soy germ concentrates are taught in PCT International Publication No. WO 02/37987, the entirety of which is incorporated herein by reference.

Some researchers have suggested adding soy isoflavone extracts to animal feed, e.g., to swine feed. Some studies test relatively high soy isoflavone concentrations in the feed, e.g., 1500-1600 ppm or higher. Although soy isoflavone extracts may be a cost-effective dietary supplement for humans, using such extracts in animal feed compositions, particularly in livestock feed compositions, is cost prohibitive for commercially-produced feeds. Depending on the extraction method, the relative proportions of daidzin, genistein, and glycitein in soy isoflavone extracts can also differ substantially from the natural balance in the soybeans or soy germs.

### DETAILED DESCRIPTION

A. Overview

Various embodiments of the present invention provide feed compositions, e.g., for livestock, fish, or companion animals, and methods of making feed compositions. One embodiment of the invention provides a feed composition that comprises soy meal. The soy meal is no more than about 20 wt. % of the feed composition. The soy meal also has a soy isoflavone content that provides the feed composition with a soy isoflavone concentration, normalized to aglycone content, of about 250-1400 ppm.

A feed composition for domestic mammals in accordance with another embodiment of the invention includes soy meal and a non-soy fraction. The soy meal is no more than about 20 wt. % of the feed composition and has a soy isoflavone content that provides the feed composition with a soy isoflavone concentration, normalized to aglycone content, of about 500-1400 ppm. The non-soy fraction may comprise at least one component selected from a group consisting of bone meal, blood meal, poultry byproduct meal, tallow, wheat middlings, roughage products, oat groats, alfalfa meal, bakery by-products, brewers dried grains, distillers dried grains and solubles, citrus pulp, beet pulp, corn gluten feed, corn gluten meal, cottonseed meal, fish meal, hominy feed, kelp meal, linseed meal, sunflower meal, canola and rapeseed meal, and rice bran.

A further embodiment of the invention provides a method of producing a domestic animal feed composition that has a target range of soy isoflavone concentration. In accordance with this particular method, the isoflavone content of a soybean meal fraction and the isoflavone content of a soy germ meal fraction are compared to the target range. The soy germ meal fraction has a higher isoflavone content than the soybean meal fraction. This comparison may be used to help determine a proportion of the soybean meal fraction and of the soy germ meal fraction that will yield an animal feed having a total soy isoflavone content in the target range. The determined proportions of the soybean meal fraction, soy germ meal fraction, and non-soy fraction may be blended. The non-soy fraction may include at least one of the components listed in the preceding paragraph.

For ease of understanding, the following discussion is broken down into two areas of emphasis. The first section describes aspects of feed compositions in certain embodiments of the invention. The second section outlines methods of producing feed compositions in accordance with other embodiments of the invention.

B. Animal Feed Compositions

Embodiments of the invention provide feed compositions for domestic animals, particularly domestic mammals. As used herein, “domestic animals” refers to livestock (i.e., animals raised for profit, including poultry and domestic mammals such as swine, ruminants, and horses), fish (including both fish and shellfish), and pets or companion animals (e.g., dogs, cats, and gerbils). As outlined below, some of these feed compositions are believed to have health benefits, e.g., when used as a swine feed for swine populations maintaining a response to viral exposure.

Feed compositions in embodiments of the invention may include a soy meal and a non-soy fraction. The non-soy fraction can have any composition suitable for the animal for which the feed is intended. As is known in the art, the composition even for a particular species of animal may be varied significantly to achieve a desired nutrition profile and suitable cost of materials. The non-soy fraction will generally include one or more grains, other energy sources such as fat or fiber, nutritional supplements (e.g., amino acids, vitamins, and/or minerals) and/or additional protein sources. The non-soy fraction may comprise any non-soy ingredients those of ordinary skill in the art would recognize as acceptable for domestic animal feed. Examples of the components of the non-soy fraction suitable for domestic animals feeds are identified in the 2003 Official Publication of the Association of American Feed Control Officials, Inc. (AAFCO) of Oxford, Ind., USA, or any later edition of the AAFCO Official Publication. (The entirety of the 2003 Official Publication of AAFCO is incorporated herein by reference.) In one embodiment, the non-soy fraction includes at least one, e.g., two or more, components selected from a group consisting of bone meal, blood meal, poultry byproduct meal, tallow, wheat middlings, roughage products, oat groats, alfalfa meal, bakery by-products, brewers dried grains, distillers dried grains and solubles, citrus pulp, beet pulp, corn gluten feed, corn gluten meal, cottonseed meal, fish meal, hominy feed, kelp meal, linseed meal, sunflower meal, canola and rapeseed meal, and rice bran.

The soy meal comprises a mixture of whole soybean meal and soy germ meal. As explained below, the relative proportions of the soybean meal and the soy germ meal may be selected to yield a soy meal with a desired total isoflavone content. One or both of the soy germ meal and the soybean meal may be a defatted soy meal, e.g., a soy meal from which soybean oil or soy germ oil has been extracted, or a meal that has not been defatted. In one embodiment, the soy germ meal is made from a soy product that is relatively pure soy germ, e.g., with soy germ comprising about 90 wt. % or more of the soy product, with the balance comprising remaining unseparated meats and hulls. In one particular embodiment of the invention, the soy product used to produce the soy germ meal includes soybean meats, hulls, and germs, with the germs comprising at least about 30 wt. %, e.g., about 30-70 wt. %, of the soy product. In one useful embodiment, the soy germ meal is produced by extracting oil from a soy product having at least about 50 wt. % soy germs. This soy product may be separated from whole soybeans in the process outlined in PCT International Publication No. WO 02/37987, for example.

The isoflavone content of the soy meal will depend, at least in part, on the desired isoflavone content of the final feed composition and the relative proportions of the soy meal and the non-soy fraction. As explained below, some embodiments of the invention employ no more than about 20 wt. % of soy meal in the feed composition and have a soy isoflavone concentration, normalized to aglycone content, of about 250-1400 ppm. If the feed composition includes about 20 wt. % of the soy meal, the 250-1400 ppm target range of isoflavone concentration would call for a soy meal having about 1250-7000 ppm of isoflavone. In other embodiments, soy meal comprises no more than about 10 wt. % of the feed composition, which would require a soy meal having an isoflavone content of about 2500-14000 ppm to hit the 250-1400 ppm target range for the feed composition. At even lower soy meal concentrations, the soy isoflavone content of the soy meal may need to be even higher to reach the same target range in the feed composition. In one embodiment, the soy isoflavone content of the soy meal is between about 1250 and about 14000 ppm.

The relative proportions of the soybean meal and the soy germ meal can vary significantly to achieve the desired isoflavone content in the soy meal. In one embodiment, the soy meal includes about 35-80 wt. % soy germ meal and a remaining portion, which may comprise the balance of the soy meal, of soybean meal (which may have had some proportion of the husks removed). For example, a soy meal comprising about 40-60%, e.g., about 50%, soy germ meal is expected to yield appropriate soy isoflavone contents for many applications.

In one embodiment, the soy isoflavones in the feed composition are a natural component of the soy meal instead of isoflavones that are chemically separated from soybeans or soy germs and subsequently added back to the feed composition. In one particular embodiment, the feed composition is substantially free from soy isoflavone extract.

The soy isoflavone profile of defatted soy germ meal is comparable, on a proportional basis, to the natural balance of soy isoflavones of the original, non-defatted soy germ. The soy germ meal that results from extracting the soy germ oil also has a proportionally higher soy isoflavone content than a whole soybean meal. The examples set forth below also demonstrate beneficial results from feed compositions having soy isoflavone concentrations below those used in most scientific studies to date, e.g., about 250-1400 ppm. The use of soy germ meal to increase the soy isoflavone concentration of the feed composition provides a commercially viable path to produce an isoflavone-enhanced feed composition that is expected to have appreciable health benefits at an acceptable cost.

The soy isoflavone concentration in the feed composition can be varied as desired, depending in part on the relative costs of the soybean meal and the soy germ meal. In one particular embodiment, the soy isoflavone concentration in the feed composition is between about 500 ppm and about 1400 ppm. In another embodiment, the soy isoflavone concentration is about 250-1200 ppm. In one advantageous embodiment, the soy isoflavone concentration in the feed composition is about 800-1200 ppm. Soy isoflavone concentrations in these ranges can be fairly readily obtained by employing a soy meal in accordance with embodiments of the invention at a level of about 10-20 wt. % of the feed composition.

### EXPERIMENTAL EXAMPLES

### Example 1

Nursery pigs in three different rooms were fed controlled diets consisting of one of seven different feed compositions. All seven of these compositions were based on the same conventional swine feed formulation, but the source of soy protein and soy isoflavone concentration differed from one composition to another. One of these compositions (composition D) comprised about 20.1% of a soybean meal having about 48% protein content (SBM48). Each of the other feed compositions used varying amounts of soybean meal or soy germ meal, together with sufficient soy protein concentrate to yield a combined soy inclusion that includes about the same soy protein content as composition D. In particular, composition A included only trace amounts (about 3 ppm) of isoflavone and derived the entire soy protein content from the soy protein concentrate. Composition B included about 6.7% SBM48 and a balance of soy protein concentrate to yield a feed composition having about 200 ppm isoflavone. Composition C included about 13.3% SBM48 and a balance of soy protein concentrate to yield a composition with about 400 ppm isoflavone. Composition E included about 1.7% of a soy germ meal and a balance of soy protein concentrate, yielding a feed composition with about 200 ppm isoflavone. Composition F used about 3.4% of the same soy germ meal with a balance of soy protein concentrate to provide about 400 ppm Isoflavone in the feed composition. Composition G included about 5.1% of the same soy germ meal with a balance of soy protein concentrate to yield about 600 ppm isoflavone. Composition H is about the same as composition A, but about 100 ppm ethoxyquin, a known antioxidant, was added to the composition.

The nursery pigs were fed a weaning diet for about 7 days, followed by a second-stage starter diet until about 20 days total. Both of these diets included an isoflavone source and concentration as noted above, but a more conventional weaning diet was used as the base composition for the first 7 days and the second-stage starter diet was based on a more conventional second-stage feed. Table 2 reflects the average daily weight gain, feed intake, and ratio of feed to weight gain (F:G) for the different compositions from the weaning diet (days 1-7) and the second-stage starter diet (days 8-20). The largely isoflavone-free compositions A and H exhibited weight gains of 0.78 and 0.70 pounds per day. In contrast, the compositions including soy germ meal (E, F, and G) yielded weight gains of 0.83-0.90 pounds/day, a meaningful increase over the isoflavone-free compositions.

TABLE 1
Summary of Growth Performance Data

| | Days 1-7 | | | Days 8-20 | | |
|---|---|---|---|---|---|---|
| | | Feed | | | Feed | |
| Feed | Gain | Intake | | Gain | Intake | |
| Composition | (lbs/d) | (lbs/d) | F:G | (lbs/d) | (lbs/d) | F:G |
| A | 0.23 | 0.31 | 1.51 | 0.78 | 0.99 | 1.28 |
| B | 0.24 | 0.32 | 1.46 | 0.93 | 1.11 | 1.19 |
| C | 0.25 | 0.31 | 1.34 | 0.78 | 0.96 | 1.26 |
| D | 0.23 | 0.30 | 1.45 | 0.97 | 1.15 | 1.19 |
| E | 0.21 | 0.29 | 1.56 | 0.88 | 1.10 | 1.27 |
| F | 0.24 | 0.33 | 1.52 | 0.90 | 1.10 | 1.23 |
| G | 0.23 | 0.31 | 1.41 | 0.83 | 1.03 | 1.24 |
| H | 0.26 | 0.33 | 1.52 | 0.70 | 0.93 | 1.32 |

### Example 2

The impact of an isoflavone-enhanced swine feed composition In accordance with embodiments of the invention was tested in a commercial swine nursery environment. Pigs in two different nurseries, nurseries 1 and 2, were fed a controlled diet. In particular, pigs in two buildings at each nursery received a control diet comprising a conventional swine feed including standard soybean meal. Pigs in two other buildings at each nursery were given a feed that is similar to the control diet, but has enhanced isoflavone levels achieved by replacing a proportion of the standard soybean meal being with soy germ meal.

Blood was collected from 15 pigs in each building at about 3-4 weeks of age, before the pigs were vaccinated. Blood was again collected from the same 15 pigs from each building at about 8 weeks of age, before shipping. The serum collected in each of the collection stages were analyzed using ELISA to measure the titers for porcine reproductive and respiratory syndrome (PRRS) and Hi to the Pfizer strain of swine influenza virus (SIV).

Nursery 1 started with pigs that were largely positive for PRRS. Nursery 2 was initially close to PRRS negative. Both nurseries were initially SIV negative, but nursery 1 became clinically sick with SIV and the resultant SIV titer confirmed that clinical observation. Table 2 sets forth the initial and final titers for PRRS and SIV for each nursery, grouped by the feed composition.

TABLE 2
Impact of Soy Source on PRRS and SIV Titer Responses

| | Conventional Feed | | Isoflavone-Enhanced Feed | |
|---|---|---|---|---|
| Response | Nursery 1 | Nursery 2 | Nursery 1 | Nursery 2 |
| PRRS Tter Initial | 0.301 | 0.158 | 0.201 | 0.147 |
| PRRS Titer Final | 0.289 | 0.505 | 0.037 | 0.528 |
| PRRS Titer Change | −0.011 | 0.350 | −0.166 | 0.381 |
| SIV Titer Initial | 34.750 | 24.250 | 34.250 | 29.250 |
| SIV Titer | 192.500 | 28.000 | 250.800 | 31.250 |
| SIV Titer Change | 157.800 | 3.800 | 215.400 | 2.000 |

Table 2 shows PRRS titers for nursery 1 differed significantly between the conventional feed and the isoflavone-enhanced feed in accordance with an embodiment of the Invention. In particular, the isoflavone-rich feed shows a PRRS titer reduction of 0.166 in nursery 1, as compared to a much smaller reduction of 0.011 using the conventional feed at the same nursery. However, the isoflavone-enhanced feed did not elicit such a significant improvement in PRRS titer in the pigs in nursery 2. The isoflavone-enhanced feed also failed to exhibit a significant positive impact on the SIV response.

When evaluating disease titers, it can often be instructive to track the response of individual animals over the course of the test period. Using the conventional swine feed at nursery 1, about 12.5% of the animals that were initially PRRS negative seroconverted to a positive PRRS. (This may be expressed as an N-P response, wherein “N” indicates a PRRS negative status in the first blood test and “P” indicates a positive PRRS in the second blood test.) Another 12.5% of the pigs in this group were initially PRRS positive and remained positive in the second test (P-P); 55% of the animals were PRRS negative in both tests (N-N); and about 20% of the animals that were initially positive seroconverted to PRRS negative (P-N). In contrast, none of the pigs fed the isoflavone-enhanced feed composition tested as PRRS positive at the end of the study. More specifically, none of the animals exhibited an N-P or P-P response, 83.8% of the animals exhibited a N-N response, and 16.2% of the animals exhibited a P-N response, i.e., seroconverted from PRRS positive to PRRS negative. This tracking demonstrates the practical impact for individual animals of the reduced PRRS titers in Table 2 for the animals in nursery 1 that received the isoflavone-enriched feed composition.

As also suggested by Table 2, the animal tracking results for nursery 2 were less conclusive. In particular, of the animals in nursery 2 fed the conventional feed composition, 41% exhibited a N-P response, 5.1% exhibited a P-P response, 48.7% exhibited an N-N response, and 5.1% exhibited a P-N response. Comparable results were seen in the isoflavone-enhanced feed in nursery 2. In particular, of the animals fed the isoflavone-enhanced feed composition in nursery 2, 42.5% exhibited an N-P response, 5% exhibited a P-P response, 47.5% exhibited a N-N response, and 5% exhibited a P-N response.

C. Methods of Producing Animal Feed Compositions

As noted above, other embodiments of the invention provide methods of producing a feed composition for domestic animals, e.g., domestic mammals. In accordance with one particular embodiment, the isoflavone content of a supply of soybean meal and the isoflavone content of a supply of soy germ meal are determined using known analytical chemistry techniques. These isoflavone contents are compared to a target range of soy isoflavone concentration in the feed composition, e.g., about 250-1400 ppm isoflavone, enabling determination of the proportions of the soybean meal and the soy germ meal in the soy meal necessary to achieve an isoflavone concentration in the feed within the target range. Soy germ meal generally has less protein than soybean meal, so it may be necessary to adjust the amount of soy meal added to the feed composition to provide the requisite protein in the feed. Alternatively, the weight percent of soy meal in the feed may remain substantially constant (or may reach a maximum before the desired protein content is reached) and the desired protein content in the feed may be achieved by adjusting the composition of the non-soy fraction of the feed.

In one embodiment, the desired amount of the soybean meal, soy germ meal, and non-soy fraction can be blended into a feed composition in one blending step. In another embodiment, the soybean meal and the soy germ meal are blended into a soy meal premix. This premix can be prepared in advance, if so desired, and then blended with the non-soy fraction of the feed as needed. Utilizing the soy meal premix can also help standardize plant process instead of having to make changes for each new batch of soybean meal and/or soy germ meal.

The above-detailed embodiments and examples are intended to be illustrative, not exhaustive, and those skilled in the art will recognize that various equivalent modifications are possible within the scope of the invention. For example, whereas steps are presented in a given order, alternative embodiments may perform steps in a different order. The various embodiments described herein can be combined to provide further embodiments.

In general, the terms used in the following claims should not be construed to limit the invention to the specific embodiments disclosed in the specification unless the preceding description explicitly defines such terms. The inventors reserve the right to add additional claims after filing the application to pursue additional claim forms for other aspects of the invention.

I/We claim:

1. A feed composition comprising soy meal, wherein the soy meal is no more than about 20 weight percent (wt. %) of the feed composition and has a soy isoflavone content that provides the feed composition with a soy isoflavone concentration, normalized to aglycone content, of about 250-1400 parts per million on a weight basis (ppm).

2. The feed composition of claim 1 wherein the soy isoflavone concentration is at least about 500 ppm.

3. The feed composition of claim 1 wherein the soy isoflavone concentration is no greater than about 1200 ppm.

4. The feed composition of claim 1 wherein the soy isoflavone concentration is about 800-1200 ppm.

5. The feed composition of claim 1 wherein the soy meal comprises no more than about 10 wt. % of the feed composition.

6. The feed composition of claim 1 wherein the soy isoflavones include genistein, daidzin, and glycitein.

7. The feed composition of claim 1 wherein the soy meal includes soy germ meal and whole soybean meal.

8. The feed composition of claim 1 wherein the soy meal includes about 35-80 wt. % soy germ meal and a remaining portion of whole soybean meal.

9. The feed composition of claim 1 wherein the soy meal includes about 40-60 wt. % soy germ meal and a remaining portion of whole soybean meal.

10. The feed composition of claim 1 wherein the soy isoflavone concentration is about 800-1200 ppm and the soy meal includes about 35-80 wt. % soy germ meal and a remaining portion of whole soybean meal.

11. The feed composition of claim 1 wherein the soy isoflavones are a natural component of the soy meal.

12. The feed composition of claim 1 wherein the feed composition is substantially free from soy isoflavone extract.

13. A feed composition for domestic mammals comprising soy meal and a non-soy fraction, wherein
the soy meal is no more than about 20 weight percent (wt. %) of the feed composition and has a soy isoflavone content that provides the feed composition with a soy isoflavone concentration, normalized to aglycone content, of about 500-1400 parts per million on a weight basis (ppm); and
the non-soy fraction comprises at least one component selected from a group consisting of meat and bone meal, blood meal, poultry byproduct meal, tallow, wheat middlings, roughage products, oat groats, alfalfa meal, bakery by-products, brewers dried grains, distillers dried grains and solubles, citrus pulp, beet pulp, corn gluten feed, corn gluten meal, cottonseed meal, fish meal, hominy feed, kelp meal, linseed meal, sunflower meal, canola and rapeseed meal, and rice bran.

14. The feed composition of claim 13 wherein the soy isoflavone concentration is at least about 800 ppm.

15. The feed composition of claim 13 wherein the soy isoflavone concentration is no greater than about 1200 ppm.

16. The feed composition of claim 13 wherein the soy isoflavone concentration is about 800-1200 ppm.

17. The feed composition of claim 13 wherein the soy meal comprises no more than about 10 wt. % of the feed composition.

18. The feed composition of claim 13 wherein the soy isoflavones include genistein, daidzin, and glycitein.

19. The feed composition of claim 13 wherein the soy-meal includes soy germ meal and whole soybean meal.

20. The feed composition of claim 13 wherein the soy meal includes about 35-80 wt. % soy germ meal and a remaining portion of whole soybean meal.

21. The feed composition of claim 13 wherein the soy meal includes about 40-60 wt. % soy germ meal and a remaining portion of whole soybean meal.

22. The feed composition of claim 13 wherein the soy isoflavone concentration is about 800-1200 ppm and the soy meal includes about 35-80 wt. % soy germ meal and a remaining portion of whole soybean meal.

23. The feed composition of claim 13 wherein the soy isoflavones are a natural component of the soy meal.

24. The feed composition of claim 13 wherein the feed composition is substantially free from soy isoflavone extract.

25. A method of producing a domestic animal feed composition having a target range of soy isoflavone concentration, comprising:
comparing an isoflavone content of a soybean meal fraction and an isoflavone content of a soy germ meal fraction to the target range, the soy germ meal fraction having a higher isoflavone content than the soybean meal fraction;
determining a proportion of the soybean meal fraction and of the soy germ meal fraction that will yield an animal feed having a total soy isoflavone content in the target range;
blending the determined proportion of the soybean meal fraction, the determined proportion of the soy germ meal fraction, and a non-soy fraction, the non-soy fraction comprising at least one component selected from a group consisting of meat and bone meal, blood meal, poultry byproduct meal, tallow, wheat middlings, roughage products, and oat groats, alfalfa meal, bakery by-products, brewers dried grains, distillers dried grains and solubles, citrus pulp, beet pulp, corn gluten feed, corn gluten meal, cottonseed meal, fish meal, hominy feed, kelp meal, linseed meal, sunflower meal, canola and rapeseed meal, and rice bran.

26. The method of claim 25 wherein the isoflavone content of the soybean meal fraction is greater than zero.

27. The method of claim 25 wherein the target range has a minimum soy isoflavone concentration of at least about 500 parts per million of the feed composition on a weight basis.

28. The method of claim 25 wherein the target range is encompassed by a range of about 500 parts per million of the feed composition on a weight basis (ppm) to about 1400 ppm.

29. The method of claim 25 wherein the target range is encompassed by a range of about 800 parts per million of the feed composition on a weight basis (ppm) to about 1200 ppm.

30. The method of claim 25 wherein the soybean meal fraction and the soy germ meal fraction together comprise no more than about 20 weight percent of the feed composition.

31. The method of claim 25 wherein the soybean meal fraction and the soy germ meal fraction together comprise no more than about 10 weight percent of the feed composition.

32. The method of claim 25 further comprising, prior to comparing the isoflavone contents, producing the soy germ meal by extracting a soy germ oil from a soy product including soybean meats, hulls, and germs, with the germs comprising at least about 30 weight percent of the soy product.
